(19) United States
(12) Patent Application Publication
(10) Pub. No.: US 2007/0262675 A1
(43) Pub. Date: Nov. 15, 2007

(54) Adjustable cooling machinery for optical disc manufacturing

(75) Inventors: Kai Leung Fan, Hong Kong (CN); Ming Sang Yeung, Hong Kong (CN)

Correspondence Address: SILICON VALLEY PATENT AGENCY, 7394 WILDFLOWER WAY, CUPERTINO, CA, 95014, US

(73) Assignee: Anwell Precision Technology (HK) Limited, Hong Kong (HK)

(21) Appl. No.: 11/744,880

(22) Filed: May 6, 2007

(30) Foreign Application Priority Data
May 10, 2006 (CN) 200610078731.3

(51) Int. Cl. H02N 11/00

(52) U.S. Cl. 310/300

(57) ABSTRACT

Adjustable cooling machinery for optical disc manufacturing is described. According to one exemplary embodiment, the adjustable cooling machine can be easily configured to allow two different diameters (e.g., 120 mm and 80 mm) of optical discs to be cooled in an optical disc manufacturing production facility. Specifically, the adjustable cooling machine can be adjusted from a first to a second configuration by changing few screws or locknuts and a connecting belt. According to one aspect of the present invention, the adjustable cooling machine comprises three identical spiral grooved shafts supported at either end by a pair of support structures via respective pairs of adjustable bearings. Each of the support structures is connected to a base plate via a pair of fasteners.

### BACKGROUND OF THE INVENTION

1. Field of the Invention

The present invention generally relates to the area of optical disc manufacturing, more particularly to adjustable cooling machinery that allows easy switching between different-sized optical disc production lines.

2. Description of the Related Art

Optical discs (e.g., Compact Disc (CD), Digital Video or Versatile Disc (DVD), etc.) have become very popular and used in many different applications, for example, video, audio, computer software, game consoles, digital camera, digital camcorders, data storage, etc. While optical discs look like a simple circular platter, manufacturing of optical discs require a number of production stages, for example, mastering, electroforming, replication, sputtering and lacquering (for DVD only).

Optical discs are literally made as a replica of the image on a stamper, which is loaded into an injection-molding machine in the replication stage. The stamper is created from a master in the earlier stages (i.e., mastering and electroforming). Then polycarbonate is heated to a molten state and fed into the molder, which contains the stamper. Under several tons of pressure the plastic (i.e., the molten polycarbonate) is compressed against the stamper. The replication stage ends, as microscopic pits containing content information on the stamper are pressed into the plastic made from polycarbonate. The temperature of optical discs (i.e., polycarbonate) just come out the replication stage is about 100° C., which is relatively high comparing to the operating temperature of approximate 30° C. for subsequent stages (e.g., sputtering and lacquering) of the manufacturing process.

Therefore, optical discs must be chilled or cooled down before being sputtered with a semi-reflective metal layer (e.g., aluminum or gold). For a DVD disc which is formed by two disc substrates, another processing step is required to bond the two disc substrates together. After the two DVD disc substrates are replicated, a lacquer coating is applied on the top of one of the discs as bonding agent under an Ultraviolet (UV) light.

Generally, there are two different chilling or cooling processes for manufacturing optical discs: horizontal and vertical. In the horizontal chilling process, chilled air is blown through the surfaces of horizontally orientated optical discs to achieve the temperature reduction. The problem with the horizontal chilling process is that polycarbonate is still relatively soft, after exiting the replication stage, and, therefore, subject to distortion and warping due to the gravity. To overcome this problem, most of the optic discs manufacturers use the vertical chilling process. In order to ensure even cool down, vertically orientated optical discs need to be rotated constantly and propelled forward in the same time. This is achieved by a special designed chilling or cooling machinery, which is generally designed for one of the two sizes (i.e., 120 mm or 80 mm diameter) of optical disc.

To fulfill the demands of the optical discs of different diameter, two chilling or cooling machineries are required for a manufacturer. But the costs of maintaining two production lines are high, one possible approach is to completely disassemble a cooling machinery configured to produce optical discs in one diameter and then reassemble the parts to form a new machinery configured to produce optical discs in another diameter, or vice versa. However, there are drawbacks related to the approach: 1) a relatively long down or idle time in the factory; and 2) a relatively difficult realignment of the entire production line due to the complete disassembly. Both of these drawbacks lead to lost productivity in the factory.

It would be desirable, therefore, to have improved chilling or cooling machineries that facilitate different sized optical disc manufacturing production lines.

### SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Adjustable cooling machinery for optical disc manufacturing is disclosed. According to one exemplary embodiment, the adjustable cooling machine can be easily configured to allow two different diameters (e.g., 120 mm and 80 mm) of optical discs to be cooled in an optical disc manufacturing production facility. Specifically, the adjustable cooling machine can be adjusted from a first configuration to a second configuration by changing few screws or locknuts and a connecting belt.

According to one aspect of the present invention, the adjustable cooling machine comprises three identical spiral grooved shafts supported at both ends by a pair of support structures via respective pairs of adjustable bearings. Each of the support structures is connected to a base plate via fasteners (e.g., locknuts, screws). Each of the relatively hot and soft optical discs, coming out of a plastic injecting machine, is placed onto a space holder jointly created by the grooves of three synchronously rotating shafts. The chilled clean air is blown through the optical discs. Both sides of an optical disc are cooled down evenly due to the combined forward motion and rotation of the spiral grooves of the shafts. As a result, the optical discs can be cooled down properly and evenly without any warping. In addition, the relatively soft optical discs are constantly rotated through the cooling machine. Not any one point on the perimeter edge of optical discs contacts the grooves of the shafts at the same location.

According to another aspect, adjustable locations of the spiral grooved shafts are so designed or chosen such that centers of different diameter optical discs are maintained in a same position. Therefore, no adjustments are required for other parts of the optical disc production line to achieve higher production efficiency.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a diagram illustrating a side elevation view of a first configuration of an exemplary adjustable cooling machine configured to facilitate the chilling stage of an optical disc manufacturing process in accordance with one embodiment of the present invention;

FIG. 1B is a diagram showing a front elevation view of the exemplary adjustable cooling machine of FIG. 1A;

FIG. 2A is a diagram illustrating a side elevation view of a second configuration of the exemplary adjustable cooling machine of FIG. 1 configured to facilitate the chilling stage of an optical disc manufacturing process in accordance with another embodiment of the present invention; and

FIG. 2B is a diagram showing a front elevation view of the adjustable cooling machine of FIG. 2A.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

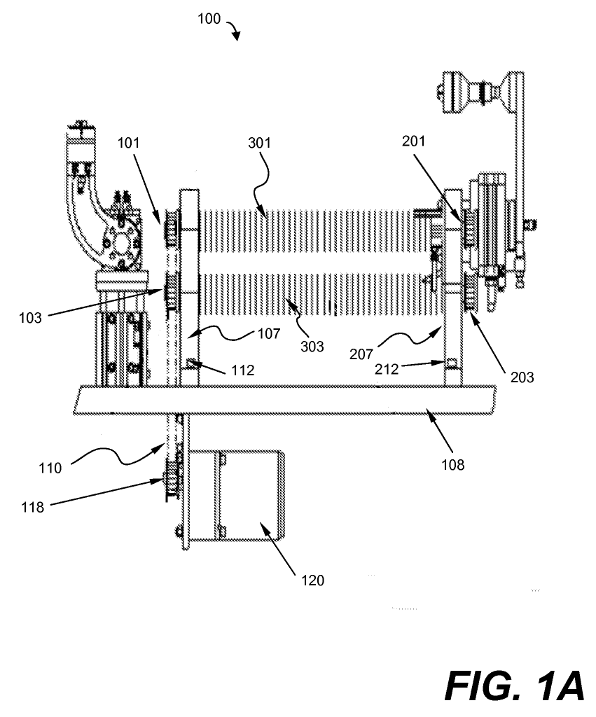

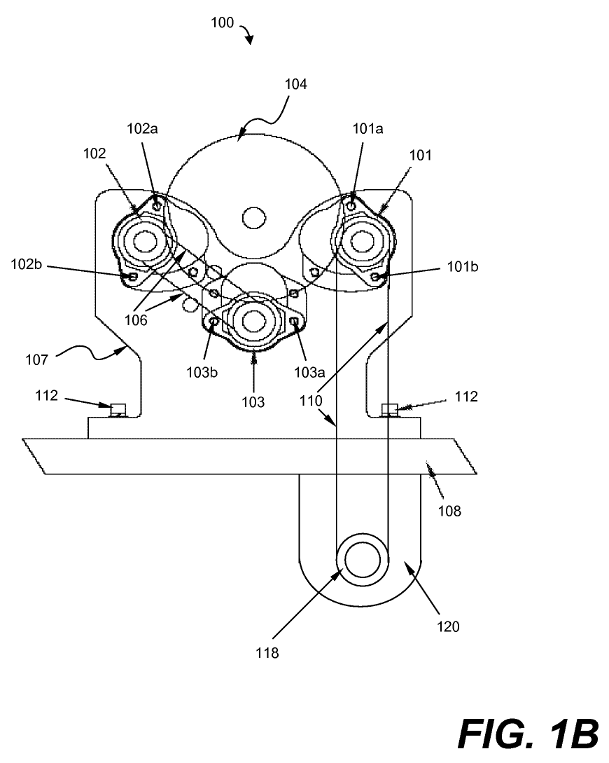

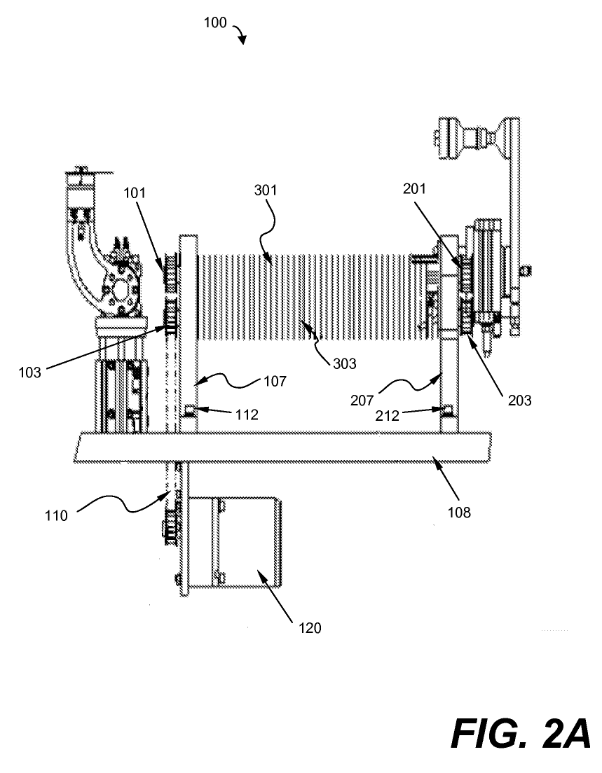

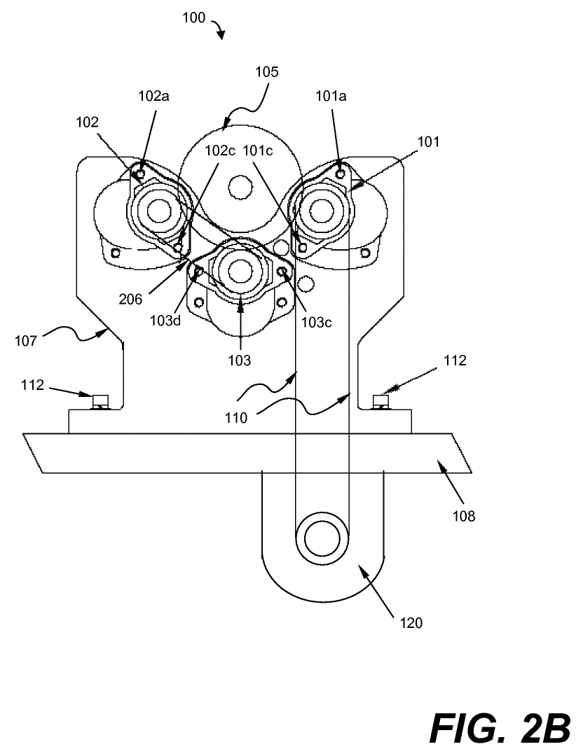

Embodiments of the present invention are discussed herein with reference to FIGS. 1A-2B. However, those skilled in the art will readily appreciate that the detailed description given herein with respect to these figures is for explanatory purposes as the invention extends beyond these limited embodiments.

Referring now to the drawings, in which like numerals refer to like parts throughout several views. According to an embodiment of the present invention, a lateral and a front (i.e., axial direction of the shaft) elevation views of a first configuration of an exemplary adjustable cooling machine 100 are shown in FIG. 1A and FIG. 1B, respectively. The adjustable cooling machine 100 comprises three identical spiral grooved shafts 301, 302 and 303 supported on both ends by a pair of support structures 107 and 207 via respective pairs of bearings 101 and 201, 102 and 202, and 103, and 203. The view of the shaft 302 and bearings 102 and 202 is blocked by that of the shaft 301, and bearings 101 and 201 hence not shown in FIG. 1A. The support structures 107 and 207 are connected to a base plate 108 via a pair of fasteners 112 (e.g., locknuts) and a pair of fasteners 212, respectively.

The adjustable cooling machine 100 further comprises an electronic motor 120, which converts electrical energy (e.g., electricity, battery, etc.) into mechanical energy to rotate a pulley 118 mounted on a rotor axle of the motor 120. Rotary or spinning motions (“rotations”) and torques of the electric motor 120 are transmitted to another pulley mounted over the bearing 101 via a motor belt 110. As a result, the spiral grooved shaft 301 is rotated and driven by the electric motor 120, and the spiral grooved shafts 302 and 303 are driven in turn by the shaft 301. In order to keep the spiral grooved shafts 302 and 303 to follow the rotations of the shaft 301 synchronously, a connecting belt 106 is used to link a pulley on the bearing 102 and a pulley on the bearing 103.

Synchronous rotations of the shafts 301, 302 and 303 provide a constant forward spiral movement of the spiral grooves on the shafts. When a vertically orientated optical disc 104 is placed on a space formed by one of the grooves of the shafts, the optical disc is propelled forward along with the rotations in a constant speed. Relatively hot and soft optical discs coming out of the replication are cooled or chilled down with clean lower temperature airs flowing between the optical discs during the journey from one end of the cooling machine 100 to another end.

The adjustable bearings 101, 102 and 103 are fastened to the support structure 107 at one end (i.e., front end) of the shafts. Each of the bearings 101, 102 and 103 is connected to the support structure 107 through two locking screws (e.g., locknuts). Specifically, the bearing 101 is secured by a pair of screws 101a and 101b, the bearing 102 is secured by screws 102a and 102b, and the bearing 103 is by screws 103a and 103b, respectively. The connections between the bearings 201, 202 and 203 and the support structure 207 at one end (i.e., back end) of the shafts are the same or substantially similar to that of the front end.

In the first configuration, the spiral grooved shafts 301, 302 and 303 together with corresponding bearings 101, 201, 102, 202, 103 and 203 are so positioned on the support structures 107 and 207 to form a holding space in which vertically orientated optical discs 104 are placed for the chilling stage of the manufacturing process. For example, the first configuration is configured to accommodate 120 mm diameter optical discs 104.

FIGS. 2A and 2B show a lateral elevation view and a front elevation view of a second configuration of the exemplary adjustable cooling machine 100, respectively, to accommodate optical discs having a smaller diameter, for example, 80 mm diameter optical discs 105, than the optical discs being cooled in the first configuration, f.

Most of the second configuration is similar to the first configuration, except the locations of the spiral grooved shafts 301, 302 and 303 and corresponding bearings 101, 201, 102, 202, 103 and 203. In particular, the bearing 101 is fastened to the support structure 107 with screws 101a and 101c, the bearing 102 with screws 102a and 102c, and the bearing 103 with screws 103a and 103c. As a result of the different locations of the bearings 101, 102 and 103, a different connecting belt 206 is used to link the bearing 102 and 103, and the electric motor 120 is adjusted to a new location directly under the bearing 101. In FIG. 2A, the views of the spiral grooved shafts 301 and 303 are overlapped due the new locations. The rest of the second configuration is the same as the first configuration. Therefore, the exemplary cooling machine 100 can be adjusted between the first and the second configurations with a relatively straight forward procedure.

The procedure to convert the first configuration to the second configuration is listed as follows:
1) rotating the bearing 101 about the screw 101a from a position at the screw 101b to another position at the screw 101c;
2) rotating the bearing 102 about the screw 102a from a position at the screw 102b to another position at the screw 102c;
3) shifting the bearing 103 up from original locations of the screws 103a and 103b to new locations of the screws 103c and 103d;
4) replacing the first connecting belt 106 with a second connecting belt 206; and
5) adjusting the electric motor to a location directly under the bearing 101.
   To convert the second configuration to the first configuration, the procedure is similar except the screws are adjusted in a reverse direction to the direction described above. It is evident that the procedure of adjusting the adjustable cooling machine 100 is simple and easy to perform. As a result, the time period required to do the conversion is shorten using the exemplary adjustable cooling machine thereby achieving higher productivity.

Although an exemplary embodiment of invention has been disclosed, it will be apparent to those skilled in the art that various changes and modifications may be made to achieve the advantage of the invention. It will be obvious to those skilled in the art that some components may be substituted with another component providing same function. The appended claims cover the present invention.

We claim:

1. An apparatus for chilling optical discs, the apparatus comprising:
a first, a second and a third spiral grooved shaft configured to form space holders by the grooves of the shafts to hold the optical discs of a first diameter to be chilled;
a first, second, and third pair of adjustable bearings configured to support the first, second, and third shaft at both ends, respectively; and
an electric motor configured to rotate the shafts via a pulley mounted over one of the first pair of adjustable bearings, wherein the adjustable bearings is readily adjusted such that the shafts are reconfigured to hold the optical discs of a second diameter.

2. The apparatus of claim 1, further comprising a motor belt configured to transmit rotations of the electric motor to rotations of the first pair of adjustable bearings and further to the first shaft.

3. The apparatus of claim 2, further comprising a connecting belt configured to link a pulley mounted on the second pair of adjustable bearings and a pulley mounted on the third pair of adjustable bearings such that the second and the third shafts synchronously follow the rotations of the first shaft.

4. The apparatus of claim 3, further comprising:
a base plate; and
a pair of support structures mounted on the base plate via locking screws, the pair of support structures is located at either of the shafts and is configured to support the shafts through respective pairs of adjustable bearings.

5. The apparatus of claim 3, wherein each of the first and the second pair of adjustable bearings is connected to one of the support structures via an upper screw and a lower screw.

6. The apparatus of claim 5, wherein the upper screw is not adjustable and the lower screw is adjustable.

7. The apparatus of claim 3, wherein each of the third pair of adjustable bearings is connected to one of the support structures via two screws orientated in a same elevation.

8. The apparatus of claim 7, wherein both of the two screws are adjustable.

9. The apparatus of claim 8, wherein the two screws are adjusted up or down in a same elevation.

10. The apparatus of claim 3, wherein the electric motor is securely connected to the base plate.

11. The apparatus of claim 3, wherein the first, second and third shafts are perpendicular to the pair of supported structures.

12. The apparatus of claim 1, wherein the first, second and third shafts are orientated parallel to one another.

13. The apparatus of claim 1, wherein center of the optical discs of the first diameter and center of the optical discs of the second diameter are positioned at a same elevation.

14. The apparatus of claim 13, wherein the first diameter is 120 mm and the second diameter is 80 mm.

15. A method for adjusting the apparatus of claim 2, the method comprising:
rotating each of the first pair of adjustable bearings about an upper screw of the first pair to a first new location;
rotating each of the second pair of adjustable bearings about an upper screw of the second pair to a second new location;
shifting each of the third pair of adjustable bearings in the vertical direction to a third new location;
replacing the connecting belt configured to link the second shaft and the third shaft; and
adjusting the electric motor to a location directly under the first pair of adjustable bearings.
